(19) United States
(12) Patent Application Publication
(10) Pub. No.: US 2026/0181519 A1
(43) Pub. Date: Jun. 25, 2026

(54) SYSTEMS AND METHODS FOR INTELLIGENT SPECTRUM-AWARE ROUTING OF LAST-MILE VIDEO TRAFFIC

(71) Applicant: Adeia Guides Inc., San Jose, CA (US)

(72) Inventors: Serhad Doken, Bryn Mawr, PA (US); Dhananjay Lal, Englewood, CO (US)

(21) Appl. No.: 18/989,258

(22) Filed: Dec. 20, 2024

(51) Int. Cl. H04W 40/12

(52) U.S. Cl. CPC H04W 40/12

(57) ABSTRACT

A plurality of channels over which devices may communicate with a network access point to communicate with one or more network nodes communicatively coupled to the network access point are monitored. Based on the monitoring, a channel priority level is assigned to each channel. Data traffic on logical connections over the plurality of channels between a plurality of devices and the network access point are also monitored. A data traffic type is determined for each logical connection. Based on the type of data traffic present on a given logical connection, a traffic priority level is assigned to that logical connection. Based at least in part on the traffic priority level assigned to each logical connection and the channel priority level assigned to each channel, a first channel is assigned to the respective logical connection. The logical connection then communicates with the network access point over the first channel.

### BACKGROUND

This disclosure relates to data traffic routing at last-mile access points. In particular, solutions for spectrum-aware data traffic steering are provided.

### SUMMARY

Video streaming has become ubiquitous and people are now using streaming services almost constantly. Streaming sessions may be used for live video or video-on-demand (VOD or SVOD). People are also enjoying content on social media (e.g., TikTok, Instagram, YouTube, etc.) which may consist of numerous short form video sessions, with frequent channel changes in the form of swiping up or down. Aspirations of being social influencers or streamers on platforms like YouTube means many streaming upload sessions. With increasing resolutions (such as 4K and 8K streaming) and an increase in interactive services that are very sensitive to latency (such as video conferencing, gaming, massive scale live sports streaming, or micro betting) results in a lot of variety in the nature of video services.

These increases in the number and type of video service sessions occur not only in public spaces (e.g., event venues), but also in basic residential scenarios. The number of connected devices (such as phones, laptops, gaming consoles, tablets, smart TVs) in people's homes has also been increasing. At any time, a multitude of streaming sessions may be active in a single home. Some of these sessions are live video sessions. Some of these sessions may only use the downlink (i.e., primarily downloading video data with minimal upload traffic), some only use the uplink (i.e., primarily uploading video data with minimal download traffic) and some use both at the same time. While one person is gaming on a first device, another may be watching a movie (e.g., using Netflix) on a second device and a third person may be streaming a live sports event (e.g., a Thursday Night Football game) on a third device.

Primarily, Wi-Fi is used for video distribution. As an unlicensed spectrum, Wi-Fi is sensitive to collisions and retransmissions, negatively affecting the performance of such services. Problems generally seen during such circumstances include buffering, stalls, freezes, frame drops (resulting in pixelization or other visual artifacts), audio-video sync loss, or even down service situations. Video packets inevitably get lost, which results in rebuffering video and inconsistent audio quality. Moreover, real time streams may be disrupted by other streams. In general, congestion is inevitable due to the degree of simultaneous activity. Another common problem seen in such situations is the lag between two devices simultaneously receiving the same live video stream, even if the devices are at the same last mile network.

Despite the roll out of the latest 5G cellular connectivity such as in the form of Fixed Wireless Access (FWA), the “last mile” (or the portion of the “last mile” that operates within a premises) of 5G FWA is yet again Wi-Fi in order to serve both fixed and mobile devices in the premises. Furthermore, as we move into the spatial computing world, augmented reality (AR), mixed reality (MR), and virtual reality (VR) will become more prevalent and pervasive and will require new solutions (e.g., due to high bandwidth and/or low latency requirements of such applications). There is also a high cost and complexity of rolling out such solutions.

While some current solutions for reducing or avoiding data traffic problems focus on the traffic between the source and destination, a video service provider has a ceiling for the quality control about how their service is delivered once the service is on Internet or arrive to the residence. Though it is possible to improve the service performance via CDNs, their positive impact is also limited once packet transport or other traffic from the video service arrives at the last mile, especially due to other application traffic also travelling through the last mile, be it video traffic or any other data traffic. While there may be other non-video traffic present on that last mile, it is expected that the bulk of the traffic payload may belong to the video services. Regardless, even such non-video traffic may have a negative effect, such as downloading a very large file, while a live video streaming session is going on, at that last mile (say residence or venue etc.).

The Transmission Control Protocol (TCP) was developed in the early 1970s as a reliable transport protocol for the internet. It is one of the core protocols of the Internet Protocol (IP) suite. TCP is a connection-oriented protocol that ensures the reliable transmission of data between devices over a network, handling packet loss, retransmissions, and maintaining the order of packet. It operates at the transport layer of the TCP/IP model (which predates the OSI model), sitting above the Internet layer (which includes IP) and below the application layers.

Generally speaking, the transport layer acts as a liaison between the abstract world of applications and the concrete functions of lower layers, providing a logical communication channel for applications running on different hosts.

TCP works by first establishing a connection using a three-way handshake. The sender then breaks the data to be sent into small packets that are numbered sequentially and that include an acknowledgment number to keep track of the order and ensure reliability. The receiver acknowledges the successful receipt of packets. If a packet is missing or corrupted, the sender retransmits that specific packet. Once all data has been sent and acknowledged, TCP closes the connection between the sender and receiver. TCP has numerous advantages, including (i) reliability (TCP facilitates accurate transmission of data, without loss or corruption, in the correct order); (ii) error correction (TCP can detect and correct errors, requesting the retransmission of corrupted packets); (iii) guaranteed delivery (data sent using TCP is guaranteed to reach the destination); and (iv) order preservation (TCP maintains the order of packets, ensuring that they are received and processed in the correct sequence). On the other hand, the features that ensure reliability (error correction, flow control, congestion control) add overhead to TCP, making it slower than desired. Further, due to its focus on reliability, TCP introduces latency, which can be problematic for time-sensitive applications like online gaming, live video streaming, or real-time voice communication.

The User Datagram Protocol (UDP) was developed after TCP as part of the original design of the Internet Protocol (IP) suite. It was developed to complement TCP by offering a lighter-weight and faster transport protocol for scenarios where reliability is not the top priority (e.g., especially for time-sensitive applications like gaming, voice-over-IP, and real-time video streaming, where occasional packet loss is acceptable). In short, UDP is faster and more efficient than TCP for certain types of network communications, but less reliable. UDP is a connectionless protocol. It does not establish a formal connection between the sender and the receiver before sending data. It simply sends data packets, called datagrams, to the destination IP address without confirming that they've arrived. Each datagram is sent independently, meaning it might take a different path through the network to the destination. Further, the recipient does not send acknowledgments or provide feedback about whether the packets were received or their condition. This makes UDP faster than connection-oriented protocols like TCP. Further, UDP provides no error checking or recovery. If a packet is lost, arrives out of order, or is corrupted, it will not be retransmitted. This makes UDP more lightweight but less reliable than TCP. Additionally, UDP provides no flow control or congestion control. That is, unlike TCP, UDP does not regulate the rate at which data is sent. This means it does not slow down in response to network congestion, which can lead to packet loss in highly congested networks. Finally, UDP provides low overhead.

Quick UDP Internet Connections (QUIC) is a modern transport layer network protocol initially developed to improve the performance and reliability of internet connections. It is designed to overcome the limitations of traditional protocols like TCP, particularly in areas such as latency, security, and connection handling. QUIC is built on UDP, which enables relatively fast data transmission since UDP (a lightweight and connectionless protocol) doesn't require the same connection setup processes as TCP. This allows for fast delivery of packets without the overhead of managing connections. One of QUIC's advantages is faster connection establishment. By combining the transport and security layers, QUIC eliminates the multi-step handshake process required in protocols like TCP and TLS (Transport Layer Security), establishing connections with just one round-trip time (RTT), reducing latency. Additionally, QUIC supports 0-RTT handshakes, allowing returning users to resume connections instantly without the need for a full handshake, further speeding up repeated connections.

Another feature of QUIC is its support for multiplexing without head-of-line blocking. Unlike TCP, where packet loss on one stream can delay others, QUIC allows multiple streams to be sent over a single connection independently, ensuring that delays in one stream do not affect the others. QUIC also supports connection migration, enabling it to maintain connections even when the underlying network changes, such as switching from Wi-Fi to cellular data. This feature helps to ensure that ongoing communications, like video streams or file transfers, continue seamlessly without interruption.

Moreover, unlike UDP, QUIC incorporates advanced congestion control algorithms to optimize network performance, monitoring network conditions and adjusting the transmission rate to avoid congestion, resulting in more stable and efficient data transfer. Built-in encryption is another feature, as QUIC encrypts data at the transport layer by default, making it more secure than traditional protocols like TCP, which relies on separate security layers like TLS. Finally, QUIC includes robust error recovery mechanisms. In cases where packets are lost or delayed, QUIC can retransmit the necessary data without affecting the entire connection or stream, ensuring smoother communication.

Media over QUIC (MoQ) is a new live media protocol being developed by the Internet Engineering Task Force (IETF) that aims to improve media delivery over the internet. MoQ utilizes the QUIC protocol as its foundation to transport media content. MoQ enables low-latency media delivery, which is helpful for applications like live video streaming, gaming, VR, and real-time communications (RTC). Its faster connection establishment and data transmission over the QUIC protocol make it particularly well-suited for time-sensitive media streams. MoQ leverages QUIC's native support for multiplexing, allowing multiple streams, such as video and audio, to be transmitted over a single connection while reducing the “head-of-line blocking” problem often seen in TCP. This ensures smoother media delivery, where delays in one stream do not affect others.

Additionally, MoQ benefits from QUIC's connection migration capability, allowing the connection to persist even when a user switches between networks, such as from Wi-Fi to cellular. This feature facilitates uninterrupted media playback during network changes. Security is another strength of MoQ, as QUIC uses encryption by default, ensuring the secure transmission of media streams, which is valuable for privacy-sensitive content like video conferencing or secure streaming. MoQ also takes advantage of QUIC's robust error correction and recovery mechanisms, which allow for quick recovery of lost packets without impacting overall stream quality, maintaining consistent media playback.

The benefits of using MoQ for media streaming include improved performance due to reduced connection setup time and faster data transmission, making it ideal for both video and audio streaming services. It is also optimized for mobile users, as its support for connection migration is particularly useful for those frequently switching between networks. MoQ is scalable and capable of handling large numbers of concurrent media streams, making it suitable for large-scale live streaming events by reducing or eliminating duplication of the video stream during “fan-out” of the media to multiple relays and consumers. Key use cases for MoQ include live video streaming, such as sports events or news broadcasts where low latency and smooth playback are essential, real-time communication applications like video conferencing or voice calls, and interactive media experiences in AR/VR and gaming, where fast and responsive connections are critical.

MoQ leverages a publish-subscribe (pub-sub) model to deliver media, making it suitable for streaming applications that require efficient, real-time data distribution. The pub-sub protocol implemented by MoQ supports multiple media formats, interoperability when indicating the media and media format being sent, rate adaptation strategies based on changing codec rates or chosen media encoding/qualities, and cache-friendly mechanisms. In the pub-sub model, publishers create and distribute media streams (e.g., live video, audio) as topics that subscribers can access. Clients, or subscribers, can choose to subscribe to these topics, receiving the media stream in real-time as it is published. The pub-sub architecture in MoQ facilitates scalable media delivery, as multiple clients can subscribe to a single stream without creating separate, direct connections for each one (and thus without adding significant load to the publisher's server). This reduces redundancy and optimizes bandwidth by sharing streams across subscribers.

Metadata in MoQ includes details about the media stream, such as the stream type (e.g., video or audio), codec information, bitrates, timing data, and other attributes needed to manage and render the content effectively at the relays and clients. This metadata enables synchronization of content across different streams and helps MoQ implementations keep track of different components of a stream. For instance, in a multi-language broadcast, metadata can indicate which audio stream corresponds to a particular language, enabling clients to select the correct stream based on user preferences and, e.g., allowing clients to switch between different quality levels or languages without restarting a session.

Multi-Link Operation (MLO) is a feature introduced in the IEEE 802.11be standard, also known as Wi-Fi 7. MLO allows Wi-Fi devices to use multiple frequency bands or channels, sometimes simultaneously (e.g., in Simultaneous Transmit and Receive (STR) mode), thereby significantly improving performance, reliability, and efficiency in wireless communication. Features of MLO in 802.11be include simultaneous use of multiple links, load balancing and redundancy, low-latency communication, improved spectrum utilization, and smooth switches between channels or bands.

Regarding simultaneous use of multiple links, MLO enables devices (e.g., access points and client devices) to transmit and receive data over multiple channels or frequency bands at the same time. For instance, in Multi-Channel Multi Radio (MCMR) mode, a device can use both the 2.4 GHZ, 5 GHZ, and 6 GHz bands, combining their bandwidths to increase overall throughput. In STR mode, a device may also use multiple channels simultaneously. This parallel usage reduces congestion and increases the effective data rate, especially in environments with many Wi-Fi devices or high-bandwidth applications like 4K/8K video streaming, gaming, or virtual reality.

Regarding load balancing, MLO enables intelligent distribution of traffic across multiple links to optimize performance. For example, if one channel becomes congested, MLO can automatically shift more data to a less congested channel. It also provides redundancy, improving reliability. If one link encounters interference or fails, the other links can continue transmitting data without disruption.

Regarding low-latency communication, by transmitting data over multiple paths simultaneously, MLO reduces latency and enhances the overall responsiveness of the connection. This can be helpful for latency-sensitive applications such as live streaming, online gaming, video conferencing, and augmented reality (AR)/virtual reality (VR) applications.

Regarding improved spectrum utilization, MLO allows for better use of the available wireless spectrum by dynamically selecting and aggregating channels across different bands. This leads to more efficient communication and better overall network performance, particularly in dense environments.

Regarding flexibility and seamless operation, MLO offers seamless operation across multiple links, allowing devices to maintain stable connections even when switching between channels or bands. For example, a device could shift traffic from the 6 GHz band (which offers high-speed, low-latency communication) to the 5 GHz band if there is interference, without disconnecting or degrading the user experience.

Taken in total, the features of MLO, such as its ability to combine multiple channels, makes it ideal for streaming 4K, 8K, or even higher-quality video without buffering. Further, MLO works well for AR, VR, and gaming applications due to the requirements for low-latency and high-bandwidth communication in these applications. However, simply using MLO without accounting for the various types of video streams or other data traffic can result in last-mile network performance that is no better than using SLO or even worse.

By leveraging MoQ and MLO, this disclosure provides systems and methods for intelligent spectrum aware data traffic routing. An inventory of video traffic flows in the last mile is built, and the video traffic flows are routed to the best unlicensed spectrum link and channel currently available. This may be based on nature of video session (e.g., SVOD, live, real-time, etc.). A single frequency and channel, multiple channels in a single frequency, or multiple frequencies and channels are used intelligently to achieve improved QoS. The selection of frequencies and channels may be based on video session characteristics or on frequency/channel status.

The subject matter of this disclosure enables improved usage of resources (spectrum, computing, storage) available. It also enables the increasing amount of streaming video traffic to flow without creating interference and be reliably delivered on the last mile. Thus, deployments implementing these methods will reduce cost and increase reliability, achieving the best of both worlds at the same time.

Systems and methods are described herein for intelligent spectrum aware data traffic routing. A plurality of channels over which devices may communicate with a network access point to communicate with one or more network nodes communicatively coupled to the network access point are monitored. The monitoring may include determining radio signal characteristics of each channel, channel usage, or other types of monitoring. Based on the monitoring, a channel priority level is assigned to each channel. Data traffic present on logical connections over the plurality of channels between a plurality of devices and the network access point are also monitored. Generally speaking, the term “logical connection” refers to a logical pathway that facilitates communication between two nodes or devices (e.g., a client device and a network access point). This “logical connection” represents an abstraction of the underlying one or more wired (e.g., Ethernet) or wireless (e.g., radio frequency channel) connections. This disclosure will focus on “logical connections” underlying wireless connections, such as in a Wi-Fi network. A “logical connection” may include one or more channels that facilitate communication between the two relevant devices or nodes. Each logical connection allows communication between a respective device of the plurality of devices and the network access point over at least one channel of the plurality of channels. A data traffic type is then determined for each logical connection. Based on the type of data traffic present on a given logical connection, a traffic priority level is assigned to that logical connection. Based at least in part on the traffic priority level assigned to each respective logical connection and the channel priority level assigned to each channel of the plurality of channels, one or more channels are assigned to the respective logical connection. The respective logical connection will then communicate with the network access point over the assigned first channel.

In some implementations, the network node or nodes with which a device will communicate are upstream of the network access point. For example, the network node may be a remote server available over the Internet. In some implementations, the network node or node may be downstream of the network access point. For example, the network node may be another client device that communicates with the network access point over a different logical connection (e.g., the device and node may exist on the same local area network, and may communicate with each other via the network access point).

In some embodiments, a second channel is assigned to the respective logical connection based on a channel priority of the second channel and the traffic priority level of the respective logical connection. For example, if the traffic priority level is high, such as for a live or real-time video stream, a second channel may be assigned to the logical connection to support the video stream. The second channel may be on a different frequency band from the first channel. For example, the first channel may be on a 6 GHz frequency band and the second channel may be on a 5 GHz frequency band. The logical connection may transmit data over both channels simultaneously or synchronously.

In some embodiments, determining a type of data traffic present on a respective logical connection includes determining a latency requirement associated with the data traffic. For example, a real-time online gaming session stream (i.e., a client device engaged in playing a real-time online video game) requires ultra-low latency while a streaming video-on-demand session can tolerate some latency. If the data traffic requires ultra-low latency (e.g., the data traffic type indicates that the data traffic has zero low tolerance for latency), a channel in the highest available frequency band may be assigned to the logical connection.

Determining a type of data traffic may include determining whether the traffic is upload traffic or download traffic. Alternatively or additionally, a type of data traffic may be determined from a traffic type tag included in one or more data packets. In some embodiments, deep packet inspection, a machine learning model, or other real-time analysis technique may be used to determine the properties of the media (for example, latency requirements, reliability requirements, etc.) from which the type of data represented by the data packets can be inferred or estimated. A data traffic type can then be estimated based on the inspection.

In some implementations, a latency requirement of data traffic being transmitted over a first logical connection is determined. If the data traffic requires low latency, one or more logical connections having data traffic that does not require low latency are identified. The data traffic on at least one of those logical connections is periodically suspended in order to increase available bandwidth for the data traffic being transmitted over the first logical connection. Alternatively or additionally, the channel assigned to the at least one identified logical connections is reassigned to the first logical connection and a new channel is assigned to the at least one identified logical connections. For example, a high frequency channel (e.g., a 5 GHz channel) may be assigned to an identified logical connection may be associated with low priority data traffic. The 5 GHz channel can be freed up for use by the first logical connection by reassigning a lower frequency channel (e.g., a 2.4 GHz channel) to the identified logical connection in place of the higher frequency channel.

In some embodiments, one or more devices utilizing a data connection with a network access point are identified. The network access point may be a router that connects directly to a service provider network, or may be a mesh router or other signal extender that connects to a central router through which a local network connects to a service provider network. Links are established between the network access point and each device. Each link may be a single channel in a particular frequency band, such as 2.4 GHz. A type of data traffic associated with each respective identified device is determined. For example, the data traffic may be upload traffic or download traffic. The data traffic may be a live video stream, a gaming stream, a VOD stream, or any other type of data traffic. This may be determined by accessing metadata associated with the data traffic, by analyzing the content of the data traffic, by accessing metadata associated with a current session of the respective device, or by any other suitable method or technique. A latency requirement for the data traffic may also be determined. For example, MoQ signaling may include an indication of the latency requirement for the data traffic. Based on the type of data traffic associated with each respective device, one or more channels over which that device will communicate with the network access point are assigned to the respective link between the respective device and the network access point, and a STR mode may be enabled for the respective device. In some cases, a multi-link connection mode may be enabled for the respective device instead of, or in addition to, the STR mode.

In some embodiments, a total amount of data traffic passing through the network access point is determined as a function of a total possible data throughput at the network access point, such as a percentage or proportion. If the total amount of data traffic is above a threshold proportion of the total possible data throughput, one or more links having a type of data traffic that do not require low latency may be identified. Data traffic may be periodically suspended on at least one identified link to reduce the total amount of data traffic to an amount below the threshold proportion.

If at least one device is utilizing multi-link operation, usage of a plurality of channels across a plurality of frequency bands over which each device utilizing multi-link operation may communicate with the network access point may be monitored. Each link between a respective device and the network access point may be dynamically reassigned to a different channel or frequency band based on the usage of each channel of the plurality of channels. These reassignments may be performed in real time.

In some embodiments, a priority level may be applied to each channel within a frequency band of a plurality of channels within the frequency band over which devices may communicate with the network access point based on characteristics of each channel. A modulation coding scheme may then be selectively reduced for a channel having a highest priority level.

In some embodiments, a priority level is applied to each frequency band of a plurality of frequency bands over which devices may communicate with the network access point based on characteristics of each frequency band. Data traffic requiring the lowest latency may then be assigned to a frequency band having a highest priority.

If a first device is uploading or downloading a real-time live video stream, a first stream for I-frames and a second stream for predicted frames may be identified. The first stream may then be assigned to a channel having the highest reliability.

In some embodiments, data traffic patterns may be predicted based on historical data and real-time network conditions. Channel usage may then be dynamically adjusted to accommodate the predicted data traffic patterns. In some implementations, data traffic patterns may be predicted by inputting the historical data and the real-time network conditions into a machine learning model. The model may be trained on general data usage patterns and updated based on historical data from the network access point. The machine learning model may then output one or more predicted data traffic patterns. In some implementations, channel usage is dynamically adjusted to accommodate the predicted data traffic patterns. Bandwidth may be reserved in on or more channels for use by a first device based on the predicted data traffic patterns. Such bandwidth may be reserved for a certain period of time.

In some embodiments, a priority level is applied to each channel of a plurality of channels over which devices may communicate with the network access point. The predicted data traffic patterns may indicate that a type of data traffic that will be associated with a first device will require low or ultra-low latency. Bandwidth may therefore be reserved for use by the first device in a first channel having a highest priority level.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts a data traffic flows between devices and a network access point using different frequency bands, in accordance with some embodiments of this disclosure;

FIG. 2 depicts an illustrative assignment of priority levels to each channel of a plurality of channels, in accordance with some embodiments of this disclosure;

FIG. 3 depicts an illustrative data flow using different channels for upload traffic and download traffic, in accordance with some embodiments of this disclosure;

FIG. 4 depicts an illustrative data flow in which two channels are used simultaneously for download traffic, in accordance with some embodiments of this disclosure;

FIG. 5 depicts an illustrative data flow in which two channels are used synchronously for upload traffic, in accordance with some embodiments of this disclosure;

FIG. 6 is a block diagram depicting components and data flow therebetween of a network access point, in accordance with some embodiments of this disclosure;

FIG. 7 is a flowchart representing an illustrative process for identifying traffic flows at a network access point, in accordance with some embodiments of this disclosure;

FIGS. 8A, 8B, and 8C (collectively FIG. 8) together are a flowchart representing an illustrative process for assigning a traffic flow to one or more channels based on the type of the traffic flow, in accordance with some embodiments of this disclosure;

FIG. 9 is a flowchart representing an illustrative process for performing low-latency upload transmissions, in accordance with some embodiments of this disclosure;

FIG. 10 is a flowchart representing an illustrative process for intelligent spectrum aware data traffic routing, in accordance with some embodiments of this disclosure; and

FIG. 11 is a flowchart representing an illustrative process for preemptively assigning additional channels to logical connections based on predicted data traffic conditions, in accordance with some embodiments of this disclosure.

### DETAILED DESCRIPTION

A multitude of simultaneous video streaming sessions may be active at a last-mile network access point. An event venue is one example where a high number of streaming sessions may be active Some people may be watching video session on their device while some may be streaming the event live from their phone for others to view. At the same time, other venue operations may be distributing the video within the venue. Similar network usage, on a smaller scale, may also occur in other last-mile situations (such as residences, campuses, etc.). For ease of discussion, this disclosure focuses on these smaller scale situations. However, the same principles apply to all last-mile networks.

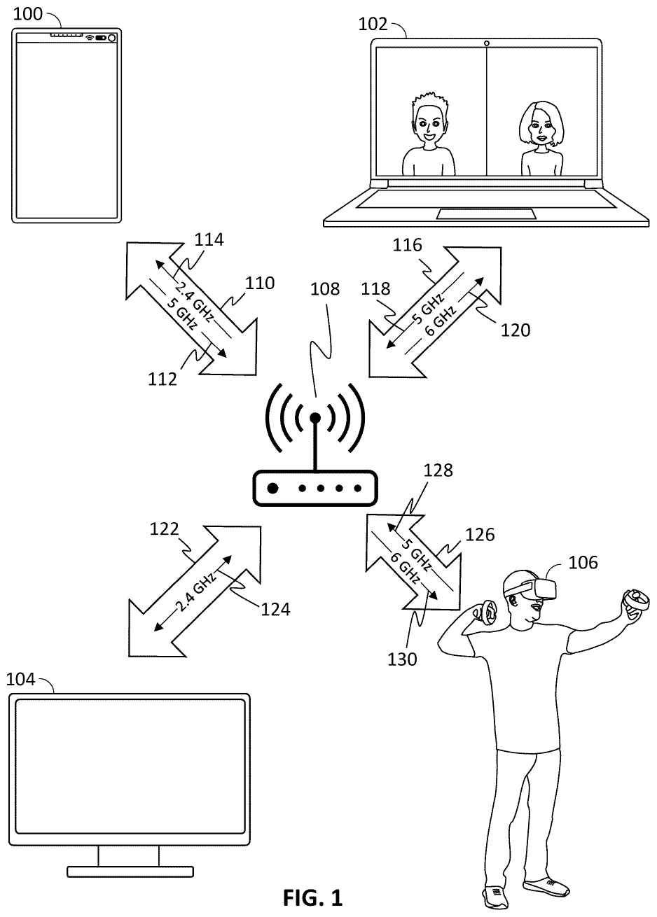

FIG. 1 depicts a data traffic flows between devices and a network access point using different frequency bands, in accordance with some embodiments of this disclosure. Several user devices, such as a smartphone 100, computer 102, smart TV 104, and VR headset 106 may all be connected to a network (e.g., the Internet) via a network access point 108. Network access point 108 may be a Wi-Fi router. Network access point 108 provides a last-mile network connection to user devices 100, 102, 104, and 106.

Depending on the type of data being uploaded and/or downloaded by each device, network access point 108 may assign different channels in one or more frequency bands to each device. Each device may then communicate with network access point 108 over its assigned channels. For example, smartphone 100 may be uploading a live streaming video. Logical connection 110 is established between smartphone 100 and network access point 108 over which smartphone 100 uploads and downloads data. Network access point 108 may determine that smartphone 100 is uploading a live video stream and assign a 5 GHz channel 112 to logical connection 110 to support the live video upload stream with minimal latency. Network access point 108 may also assign a 2.4 GHz channel 114 to logical connection 110 over which smartphone 100 may receive downstream data, such as ACK messages indicating receipt of uploaded data at a video server, or other non-latency sensitive downstream data.

As another example, computer 102 may be engaged in a video conference. Logical connection 116 is established between computer 102 and network access point 108 over which computer 102 uploads and downloads data. Network access point 108 may determine that computer 102 requires low latency and assign a 5 GHz channel 118 to support upload of live video from a camera connected to, or integrated with, computer 102. Network access point 108 may also assign a 6 GHz channel 120 to logical connection 116 over which computer 102 may stream one or more real-time video streams from other participants in the video conference.

In another example, VR headset 106 may be engaged in an online video game (e.g., a massive multiplayer online role playing game, real time strategy game, or other game requiring low or even ultra-low latency. Logical connection 126 is established between VR headset 106 and network access point 108 over which VR headset 106 uploads and downloads data. Network access point 108 may determine that VR headset 106 requires low or ultra-low latency and assign a 5 GHz channel 128 to logical connection 126 to support low latency upload of in-game actions performed by a user of VR headset 106, as well as a 6 GHz channel 130 to support low latency download of real-time in-game data.

In yet another example, smart TV 104 may be engaged in streaming video from a video-on-demand source, such as YouTube, Netflix, Hulu, etc. Logical connection 122 is established between smart TV 104 and network access point 108 over which smart TV 104 uploads and downloads data. Network access point 108 may determine that smart TV 104 does not require low latency and assign a 2.4 GHz channel to logical connection 122 over which smart TV 104 may both upload and download data.

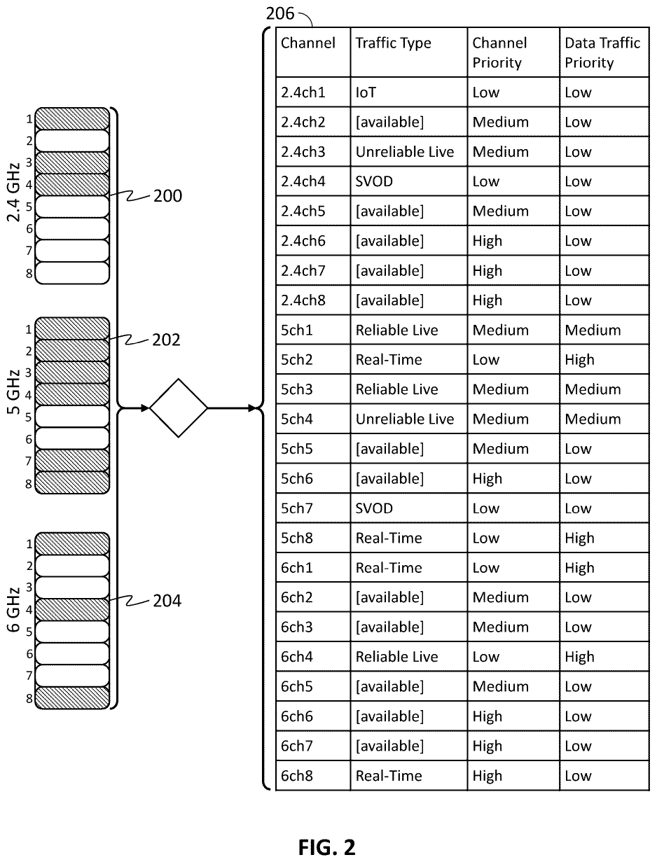

FIG. 2 depicts an illustrative assignment of priority levels to each channel of a plurality of channels, in accordance with some embodiments of this disclosure. Links between client devices and a network access point may be assigned one or more channels in one or more frequency bands. Wi-Fi 7 utilizes three different frequency bands—2.4 GHz, 5 GHZ, and 6 GHz—each of which offers unique characteristics and capabilities tailored to specific applications and performance requirements. The 2.4 GHz band spans frequencies from 2.400 GHz to 2.4835 GHz, offering longer-range connectivity due to lower propagation losses and greater penetration through obstacles, albeit at lower data rates compared to higher-frequency bands. Channel bandwidths in the 2.4 GHz band are typically limited to 20 MHz or 40 MHz, enabling robust connectivity for legacy and low-bandwidth devices such as IoT sensors.

The 5 GHz band, encompassing frequencies between 5.150 GHz and 5.850 GHz, provides a balance between throughput and range, supporting channel bandwidths of 20 MHz, 40 MHz, 80 MHz, and 160 MHz. The increased channel widths allow for higher data rates, making this band suitable for mainstream applications such as high-definition video streaming and online gaming. The 6 GHz band, ranging from 5.925 GHz to 7.125 GHz, allows channel bandwidths of up to 320 MHz. This band supports ultra-high throughput and reduced interference due to its exclusive allocation to Wi-Fi 6E and Wi-Fi 7 devices.

For illustrative purposes, FIG. 2 assumes that each of 2.4 GHz band 200, 5 GHz band 202, and 6 GHz band 204 are each divided into eight channels of identical bandwidth. Some of these channels may be in use by one or more links, while others are not currently in use. Each channel in each frequency band is monitored to determine whether it is in use. If a channel is in use, the monitoring may also determine the type of data traffic on that channel. The monitoring may also identify signal characteristics of each channel, including interference, signal strength, etc., as well as usage of each channel including whether the channel is already allocated to a connection and/or whether the channel is actively carrying data traffic.

Based on the signal characteristics of a channel, a channel priority level is assigned to that channel. Table 206 shows channel priority levels for different channels. For example, a channel in a lower frequency band (e.g., 2.4 GHz band 200) has less bandwidth, and therefore less data throughput, than higher frequency bands. Accordingly, a 2.4 GHz channel may be assigned a low channel priority level. In another example, a channel in a high frequency band (e.g., 6 GHz band 204) has higher bandwidth/data throughput and might normally be assigned a high channel priority level. However, if the channel is experiencing interference (e.g., from an adjacent channel in 6 GHz band 204 or from an environmental source), the channel may be assigned a medium or even low channel priority level.

Alternatively or additionally, based on a traffic type associated with a channel, a data traffic priority level is assigned to that channel. Table 206 also shows data traffic priority levels for different channels. For example, a channel that is currently being used for simple and/or periodic data transfer, such as by an IoT device, may be assigned a low data traffic priority level. A channel that is being used for streaming video on-demand may also be assigned a low priority. This is because, for video-on-demand, content can be downloaded and buffered ahead of a current playback position within the content, making the streaming sessions more tolerant of interruption than other types of streaming sessions. A channel that is being used for “unreliable live” content, meaning content that is live but does not require low latency, may be assigned a medium data traffic priority level because an unreliable live session can tolerate some minor interruptions. A channel that is being used for “reliable live” and “real-time” content, which require low latency and high bandwidth, may be assigned a high data traffic priority level.

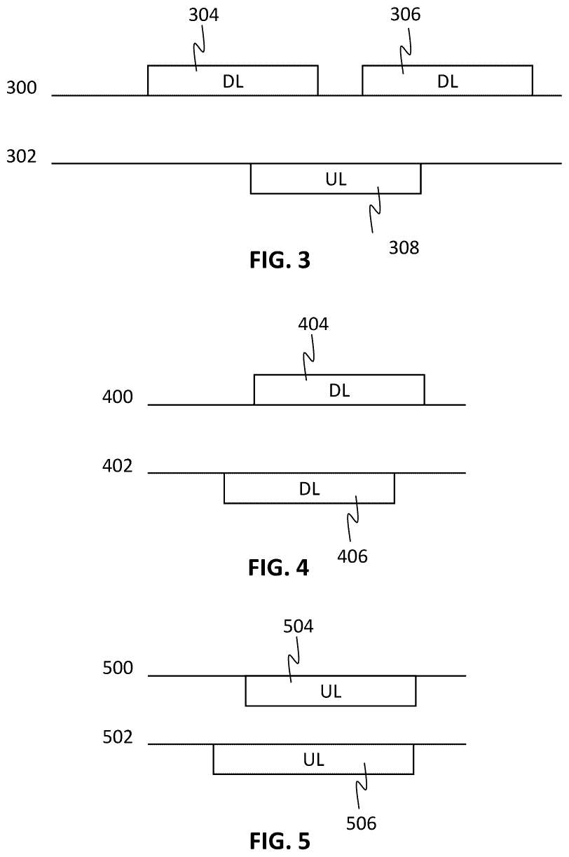

FIG. 3 depicts an illustrative data flow using different channels for upload traffic and download traffic, in accordance with some embodiments of this disclosure. Spectrum is the cornerstone of wireless communication, and the emergence of new generation of wireless communication technologies usually accompanies the use of new spectrum bands. However, the obtainable bandwidth over 2.4 GHz and 5 GHz frequency bands cannot meet the throughput and latency requirements of emerging services such as AR/VR and online gaming. The 6 GHz band is therefore used to improve Wi-Fi peak throughput. Wi-Fi 7 supports channel bandwidths of up to 320 MHz, but only in a single radio frequency. However, the current usage of wide channels is not efficient. For example, if the primary 20 MHz subchannel which controls channel access is busy, the entire wide channel is blocked and the remaining subchannels are idle. A wide channel consists of multiple sub-bands with specific frequencies, so the properties of various parts of a wide channel are different and they may require different parameters for channel access. Through MLO, access points and client devices are able to transmit and receive data from the same traffic flow over multiple radio interfaces. For example, for a traffic flow for which MLO is enabled may use a link to which channel 300 in a first frequency band and channel 302 in a second frequency band are assigned. Data packets 304 and 306 may be downloaded over channel 300 while data packet 306 is uploaded over channel 302.

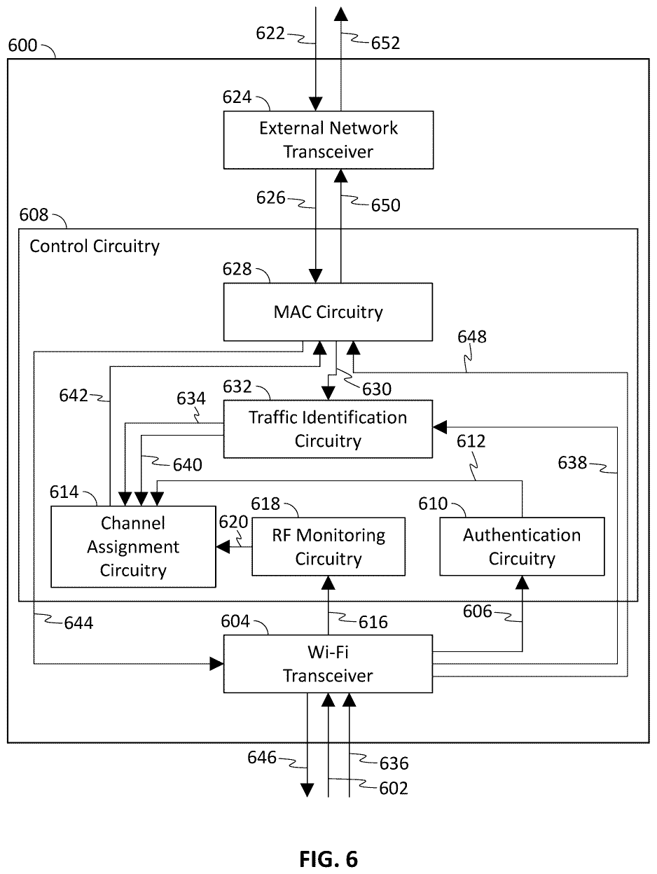

FIG. 4 depicts an illustrative data flow in which two channels are used simultaneously for download traffic, in accordance with some embodiments of this disclosure. In this example, a data traffic flow uses a link to which channel 400 and channel 402 are assigned, with each channel being in a different frequency band. Data packet 404 may be downloaded over channel 400 while data packet 406 may be downloaded over channel 402. The download of each data packet may occur simultaneously, or may temporally overlap.

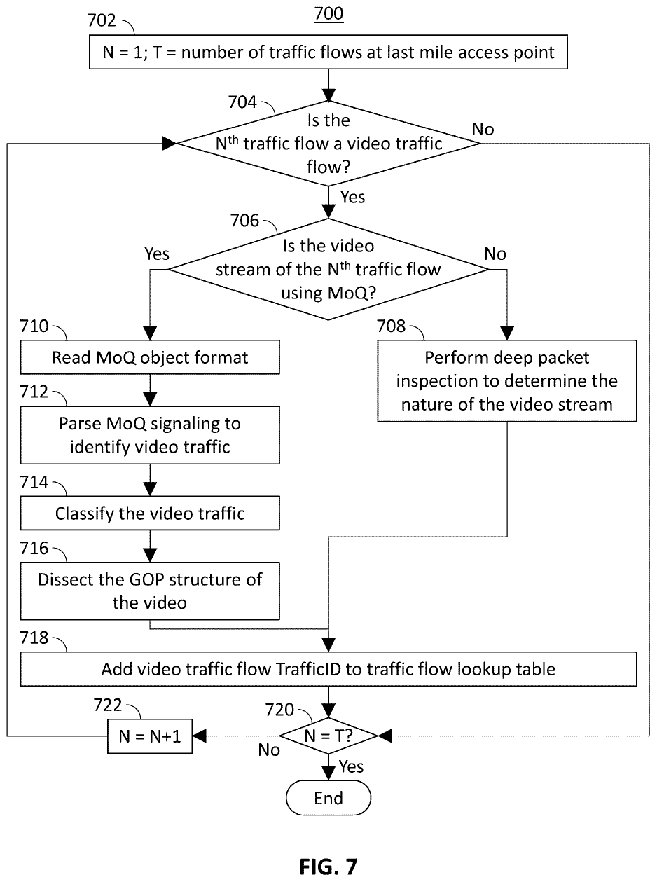

FIG. 5 depicts an illustrative data flow in which two channels are used synchronously for upload traffic, in accordance with some embodiments of this disclosure. In this example, a data traffic flow uses a link to which channel 500 and channel 502 are assigned, with each channel being in a different frequency band. Data packet 502 may be uploaded over channel 500 while data packed 506 may be uploaded over channel 502. The upload of each data packet may occur simultaneously, or may temporally overlap.

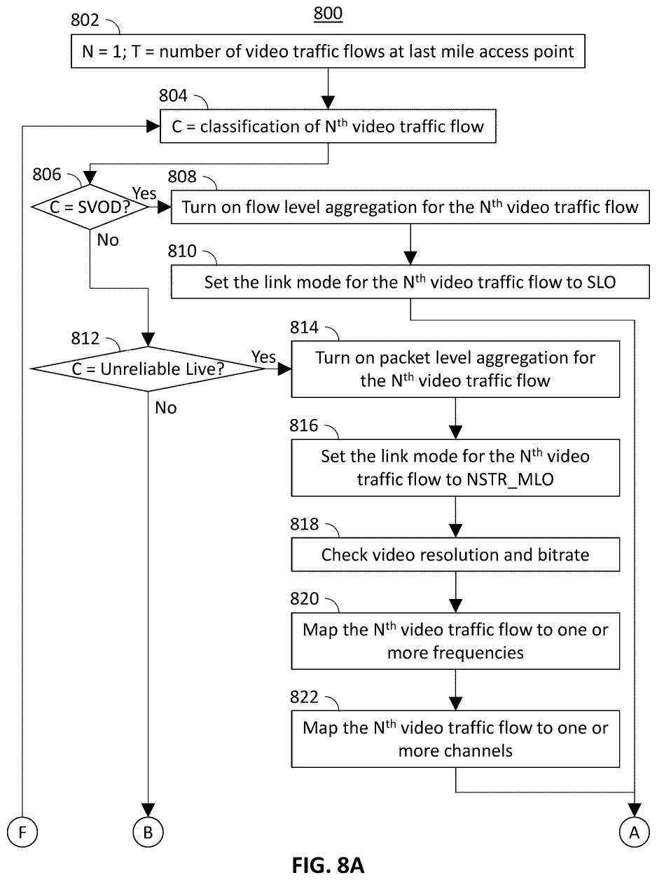

FIG. 6 is a block diagram depicting components and data flow therebetween of a network access point, in accordance with some embodiments of this disclosure. Network access point (AP) 600 manages the flow of data between connected devices and the network by utilizing MAC address association, frame processing, and medium access control mechanisms. During the association process, each device connecting to AP 600 is identified by its unique Media Access Control (MAC) address, which is recorded in an internal association table maintained by AP 600. The table maps each MAC address to an associated device and includes a unique Association Identifier (AID) assigned to the device, which is subsequently used in the headers of transmitted frames for efficient identification. When a device sends an upload packet to AP 600, AP 600 extracts the source MAC address from the frame header, verifies its association using the MAC address table, and processes the packet. For download packets destined for a device, AP 600 retrieves the destination MAC address from the packet, matches it to the corresponding device in the association table, and forwards the packet appropriately.

The process of establishing a link between AP 600 and a client device begins with the discovery and authentication phase, followed by association and channel assignment. Initially, AP 600 broadcasts beacon frames containing information about its capabilities, including supported data rates, encryption protocols, and available channels. A client device initiates the connection by sending 602 a request, which is received by AP 600 using Wi-Fi transceiver 604.

The next step is authentication. Wi-Fi transceiver 604 communicates 606 the request to control circuitry 608, where it is received at authentication circuitry 610. Control circuitry 608 may be based on any suitable processing circuitry and comprises control circuitry and memory circuitry, which may be disposed on a single integrated circuit or may be discrete components. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

The client device may exchange additional information with access point 600 to establish the validity of the connection. This can involve a simple open system authentication or a more secure authentication mechanism such as WPA2, which includes a four-way handshake to negotiate encryption keys. After successful authentication, the client sends an association request frame to AP 600, which includes the client's capabilities and supported features. AP 600 responds with an association response frame, granting or denying the request and assigning a unique Association Identifier (AID) to the client. This AID is used to identify the client in subsequent communications, particularly in managing traffic in the shared medium.

Channel assignment for the link is then determined. Authentication circuitry 610 transmits 612 an identifier of the link, as well as information about the client device, to channel assignment circuitry 614. AP 600 may operate on a specific frequency channel within the designated wireless spectrum, often chosen dynamically to minimize interference from neighboring APs or other devices. Channel assignment circuitry 614 may rely on protocols like Dynamic Frequency Selection (DFS) to scan for the clearest channel. Once AP 600 establishes a link with the client device, the communication takes place over the assigned channel. AP 600 may also use Quality of Service (QoS) mechanisms to prioritize certain types of traffic over the channel, ensuring efficient and fair access to network resources for all connected clients. Data traffic associated with the link will be routed over the assigned channel. For MLO, channel assignment circuitry 614 assigns multiple channels to the link. Data traffic is then routed over the multiple channels as needed. This will be discussed further below.

Wi-Fi transceiver 604 may also periodically transmit 616 radio information to RF monitoring circuitry 618. RF monitoring circuitry 618 determines, based on the radio information, various radio characteristics for each channel in each frequency band that AP 600 is configured to use. RF monitoring circuitry 618 determines whether a channel is experiencing interference and analyzes various radio characteristics to optimize wireless network performance. RF monitoring circuitry 618 may also utilize noise floor measurements to identify the baseline level of interference on a channel, with a high noise floor indicating significant interference from sources such as overlapping Wi-Fi networks, Bluetooth devices, or environmental factors. RF monitoring circuitry 618 may also calculate the signal-to-noise ratio (SNR) for transmissions to evaluate signal quality, where a lower SNR indicates degraded performance due to interference or weak signals.

Channel utilization metrics provide insights into how much of the channel's capacity is being used, with high utilization suggesting congestion or co-channel interference. Using advanced spectrum analysis tools, RF monitoring circuitry 618 can detect non-Wi-Fi sources of interference, measure power levels of interfering signals, and identify interference patterns such as bursts or continuous noise. RF monitoring circuitry 618 may also use Received Signal Strength Indicator (RSSI) measurements to monitor the strength of incoming packets, with significant variability or low RSSI values indicating potential interference or signal attenuation. RF monitoring circuitry 618 transmits 620 radio information for each channel to channel assignment circuitry 614. Channel assignment circuitry 614 may use the radio information in selecting channels for assignment to different client devices.

AP 600 receives 622 data traffic from an external network such as the Internet using external network transceiver 624. External network transceiver in turn transmits 620 the received data traffic to control circuitry 608, where it is received at media access control (MAC) circuitry 628. Wi-Fi 7 divides the MAC architecture into upper and lower MAC layers, with the upper layer supporting operations such as data aggregation and packet allocation and the lower layer supporting operations such as header creation and redundancy checks. In some implementations, MAC circuitry 628 may be dedicated to the operations of the upper MAC layer. MAC circuitry 628 authenticates received packets and determines to which client device (i.e., over which link) they are to be routed.

MAC circuitry 628 may transmit 630 data packets to traffic identification circuitry 632. Traffic identification circuitry 632 is configured to classify a packet based on the type of data traffic it represents. Traffic identification circuitry 632 may be used to map all the active sessions on AP 600 with their corresponding traffic. Traffic identification circuitry 632 may extract, retrieve, or otherwise access metadata of each data packet in order to determine the type of data traffic represented by the data packet. This may be implemented by parsing MoQ signaling to pull out the metadata. For legacy streams that are not using MoQ, other implementations are possible, include using camera or network-based tagging. For example, Google Cloud offers a “Live Label detection” feature via its Video Intelligence Streaming API to annotate a streaming video as a live session. Another example, is the Axis surveillance camera “Event data streaming” format that supports XML and/or ONVIF standard. Queries can be made to understand the nature (live or not) of the stream. Similarly, other industry players such as BrightCove (thru their Beacon product) and Amazon Rekognition or Kinesis Video Stream APIs can help to map live video streams. Traffic identification circuitry 632 transmits 634 a data traffic type for a given session to channel assignment circuitry 614.

Traffic identification circuitry 614 may also classify packets uploaded by client device. AP 600 may receive 636, using Wi-Fi transceiver 604, a data packet from a client device. Wi-Fi transceiver 604 may in turn transmit 638 the data packet to traffic identification circuitry 632. Traffic identification circuitry 632 may then use any of the above methods to determine a data traffic type represented by the data packet. Traffic identification circuitry 632 then transmits 640 the data traffic type to channel assignment circuitry 614.

Based on the data traffic type, channel assignment circuitry 614 may change the channel assignment for the link associated with the session, or may assign one or more additional channels to the link associated with the session. For example, if the link is originally assigned a 2.4 GHz channel and the data traffic type of the session indicates that the data traffic is a live stream, channel assignment circuitry 614 may assign a 6 GHz channel to the link in place of the 2.4 GHz channel. If the client device supports MLO and the data traffic type requires MLO, channel assignment circuitry 614 may assign one or more additional channels to the link. For example, while steaming video on demand may not require MLO, live streaming, both reliable and unreliable, as well as real-time stream (e.g., video conferencing, gaming, etc.) benefit from MLO. Accordingly, if the data traffic type indicates that the content is live streaming or real-time streaming, AP 600 may enable MLO for the link and channel assignment circuitry 614 may assign additional channels to the link.

Channel assignment circuitry 614 may transmit 642 channel assignments to MAC circuitry 628. This allows MAC circuitry 628 to properly route the data packets over the assigned channel(s). MAC circuitry 628 then transmits 644 the data packets to Wi-Fi transceiver 604 which in turn transmits 646 the data packets to the client device over the assigned channel(s). Upload data packets may be transmitted 648 from Wi-Fi transceiver 604 to MAC circuitry 628, which in turn transmits 650 the data packets to external network transceiver 624 to be transmitted 652 to a destination device (e.g., a server) over the external network.

Prioritization is important for video streams requiring low-latency. The publisher of the video stream must send the most important media first during congestion. However, priority decisions are delegated to the subscriber for the last mile. This is done via a Track Priority and Group Order field within a SUBSCRIBE command, used in the publication-subscription system through which client devices access video streams in MoQ. Within MoQ signaling, a subscriber can choose the Group Order based on the desired user experience. The command “SUBSCRIBE order=DESC” transmits new Groups first to allow skipping and is intended for low-latency live streams. The command “SUBSCRIBE order=ASC” transmits old Groups first to avoid skipping and is intended for VOD and reliable live streams.

The MoQ object structure then allows for the client device to prioritize different tracks of the stream. The command “SUBSCRIBE track=audio priority=0 order=DESC group_expires=100 ms” gives the audio track the highest priority while the command “SUBSCRIBE track=video priority=1 order=DESC group_expires=100 ms” gives the video track the second highest priority. This prioritizes the most important media during congestion (i.e., the audio) and skips the video track. This configuration is useful for real-time video streams such as video conferencing.

For unreliable live stream, the stream requires low latency, but it does need it at all costs and some video frames can be skipped. This is useful for broadcasts where latency is important but so is picture quality. For this configuration, the commands “SUBSCRIBE track=audio priority=0 order=ASC” and “SUBSCRIBE track=video priority=1 order=DESC group_expires=3 s” may be used.

Reliable live streams primarily care about picture quality. A good example is a sports game where you want to see every frame. A reliable live viewer could use the commands “SUBSCRIBE track=audio priority=0 order=ASC” and “SUBSCRIBE track=video priority=0 order=ASC” for this configuration. This will deliver both audio and video in order, and with the same priority. The viewer won't miss any content unless the publisher resets a group.

There are several different modes of MLO that can be used to route data traffic into the best suited Wi-Fi frequency bands and channels. If the stream is not live and is just a simple SVOD session, the traffic we be steered in the legacy form of SLO (Single Link Operation). In backward compatible implementations, HTTP ABR may be used for SVOD rather than MoQ. In MoQ signaling, a VOD session may be specified with the commands “SUBSCRIBE track-audio priority=0 order=ASC start=345 end=396” and “SUBSCRIBE track=video priority=0 order=ASC start=123 end=134.”

In some embodiments, HTTP3, which leverages QUIC, is used to deliver a streaming media. HTTP3 defines extensible priorities using 2 fields. First, an Urgency field, which contains an integer value in the range 0-7, indicates the importance of the requested object, with 0 being most important and 7 being the least. The default value of the Urgency field is 3. Second, an Incremental field, which is a boolean value, indicates whether the requested object can be processed as parts of it are received and read (commonly referred to as streaming processing). The default value of the Incremental field is false, indicating that the object must be received in whole before it can be processed. In some embodiments, the Urgency and Incremental values are embedded into the MoQ metadata, or a combination of the values is mapped to a priority value defined in MoQ. This is then used by the access point (e.g., AP 600) to prioritize the flow/traffic.

Simultaneous Transmit and Receive mode (STR) allows devices to transmit and receive data on different frequency bands simultaneously. This capability significantly improves data flow and reduces latency, making it ideal for applications requiring real-time data transmission, such as online gaming and video conferencing. Reliable live data traffic will therefore be steered to STR mode directly. AP 600 performs packet level fragmentation to map the MoQ stream into the appropriate MAC layer. MoQ signaling data indicating the media rate and codec rate may also be used. If the media format indicates a high-resolution video such as 1080i/p, 2K, then an upper range frequency such as 6 GHz will be used. If the resolution is low (such as 720p or 480p), 5 GHz frequency channels may be sufficient for the traffic.

For media formats that are more challenging such as 4K or 8K (or even beyond) for reliable live streams, in addition to STR, AP 600 may also enable Multi-Channel Multi-Radio mode (MCMR). MCMR involves the use of multiple radios (e.g., 5 GHz and 6 GHz) and channels to maximize data throughput and network performance. By utilizing different channels and radios, MCMR ensures that data can be transmitted more efficiently, reducing congestion and enhancing overall network speed.

Non-Simultaneous Transmit and Receive mode (NSTR) allows devices transmit and receive on different frequency bands, but not simultaneously. While NSTR does not offer the same level of efficiency as STR, it still improves data transmission compared to single-link operations by leveraging different bands for sending and receiving data. AP 600 may route unreliable live streams to NSTR mode directly. If the media format indicates a high-resolution video, such as 4K or 8K, AP 600 may us the upper range frequency such as 6 GHz. If the resolution is lower, such as 1080p or 2K, AP 600 may use the 5 GHz channels. If the resolution is low, such as 720p or 480p, 2.4 GHz may be sufficient.

If the MoQ object refers to a real-time live stream, AP 600 may further dissect the GOP structures of the video stream. The subscriber may have already made their intent explicit that they are expecting ultra-low latency within the vicinity of 100 ms. Accordingly, this stream should be treated with utmost sensitivity during the last mile routing stage. To do this, AP 600 prioritizes audio data and I-frames from each GOP, and phases in the remaining data as it is able. In some implementations where there is a high sensitivity to packet loss, a full GOP may be sent as a MoQ Group and each frame as a MoQ Frame. In other implementations where latency is to be minimized, a MoQ Group can be a frame, thereby allowing AP 600 to pick out individual video frames. For the GOP structures of this real-time stream, that means steering the specific frames separately and mapping them to the either different links or frequencies. There is therefore not only multiplexing at the QUIC level, but also at the MoQ layer for frame types. The QUIC stream priority field can be used for this. The QUIC stream priority field may be provided in the MoQ metadata. This field is read by AP 600 and used to direct higher priority QUIC streams to more reliable (wider, higher freq, etc.) Wi-Fi radio bands. This ensures that if the sender packages I-frames in a higher priority stream, they are received by the client device with greater reliability.

The further granularity of using STR mode with multiple radios using multiple channels (MCMR) allows AP 600 to route the I-Frames through the widest band available and to route P-frame and B-frames via other channels. If the widest band frequency (6 GHz) is available, AP 600 may still use it to send P-/B-frames at different channels that frequency. However, if there are multiple real-time streams being delivered by/to multiple devices at the same time, then AP 600 may even route the P-/B-frame traffic to other bands, such as 5 GHz or 2.4 GHZ, if they are not as congested.

In order to select the best frequency and best channel for the requirements of the video stream (real-time, reliable live or unreliable live or SVOD), AP 600 may perform lookups to a TrafficID flow table to assess all the network traffic that is active at AP 600, or on the entire last-mile network if there are multiple access points on the same network. In order to map the TrafficIDs for the active traffic flows, the MoQ pub/sub architecture and its metadata can be leveraged when available.

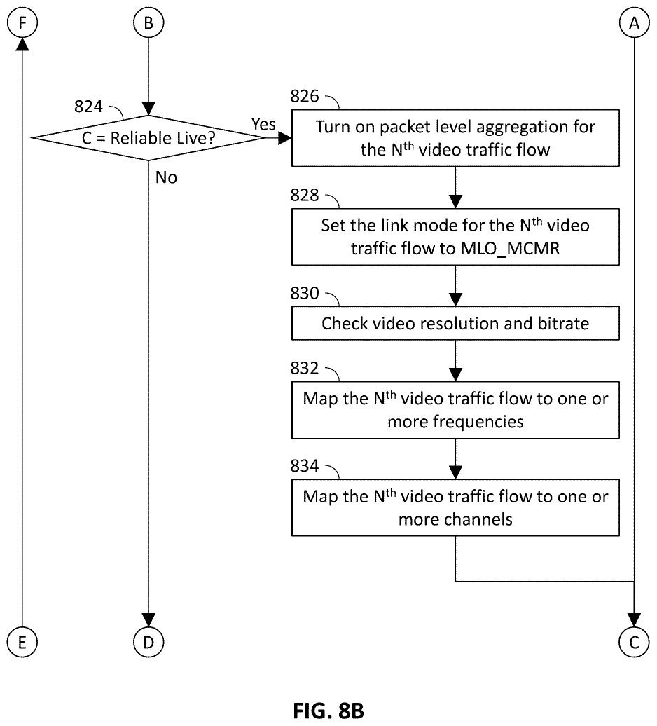

FIG. 7 is a flowchart representing an illustrative process 700 for identifying traffic flows at a network access point, in accordance with some embodiments of this disclosure. Process 700 may be implemented on control circuitry 608. In addition, one or more actions of process 700 may be incorporated into or combined with one or more actions of any other process or embodiments described herein.

At 702, control circuitry 608 initialized a counter variable N, setting its initial value to 1, and a variable T representing the number of traffic flows at AP 600. At 704, control circuitry 608 determines whether the N^{th} traffic flow is a video traffic flow. There may be many different types of traffic flows at AP 600, including IoT devices, smart assistant devices (e.g., Amazon Alexa, Google Home), in addition to video streams. If the N^{th} traffic flow is a video traffic flow (“Yes” at 704), then, at 706, control circuitry 608 determines whether the video stream of the N^{th} traffic flow is using MoQ. For example, control circuitry 608 may access metadata associated with the video stream to determine a format of the video stream.

If the video stream is not using MoQ (“No” at 706), then, at 708, control circuitry 608 performs packet-level or traffic-level analysis (for example, deep packet inspection, machine learning, etc.) to determine the nature of the video stream. This may include such methods such as inspecting the headers for particular protocols such as DASH, HLS, RTSP/RTMP etc., as well as video codec packet payloads. Control circuitry 608 may also analyze applications and endpoints involved with the stream. For example, control circuitry 608 may determine if multiple endpoints are receiving a session from the same IP addresses associated with a known video service (such as YouTube, Netflix etc.). Even if data traffic and payloads are encrypted, control circuitry 608 may identify and/or determine a signature of the traffic to understand if it has a pattern that fits into known video traffic signatures. Control circuitry 608 may also use trained neural network models to infer if the encrypted traffic is in fact live or recorded video streaming session.

If the deep packet inspection shows that a live video stream is being received from the same video service source IP address by multiple devices in the same last-mile network, control circuitry 608 can record the original clock reference of the video frames to ensure a synchronized playout on the destination client devices by coordinating a watchdog clock setting of AP 600.

If the video stream is using MoQ (“Yes” at 706), then, at 710, control circuitry 608 reads the MoQ object format. At 712, control circuitry 608 parses the MoQ signaling to identify the video traffic. At 714, control circuitry 608 classifies the video traffic. For example, the video traffic may be classified as one of SVOD, unreliable live, reliable live, or real-time.

At 716, control circuitry 608 dissects the GOP structure of the video. For example, control circuitry 608 determines which track within the stream contains I-frames, which track(s) contain P-/B-frames, and which track(s) contain audio data. After dissecting the GOP structure, or after performing deep packet inspection, at 718, control circuitry 680 adds a TrafficID corresponding to the stream to a traffic flow lookup table.

At 720, control circuitry 608 determines whether N is equal to T, meaning that all traffic flows have been processed. If N is not equal to T (“No” at 720), then, at 722, control circuitry 608 increments the value of N by one, and processing returns to 704. If N is equal to T (“Yes” at 720), then the process ends.

The actions and descriptions of FIG. 7 may be used in any other embodiment of this disclosure. In addition, the actions and descriptions described in relation to FIG. 7 may be done in suitable alternative orders or in parallel to further the purposes of this disclosure.

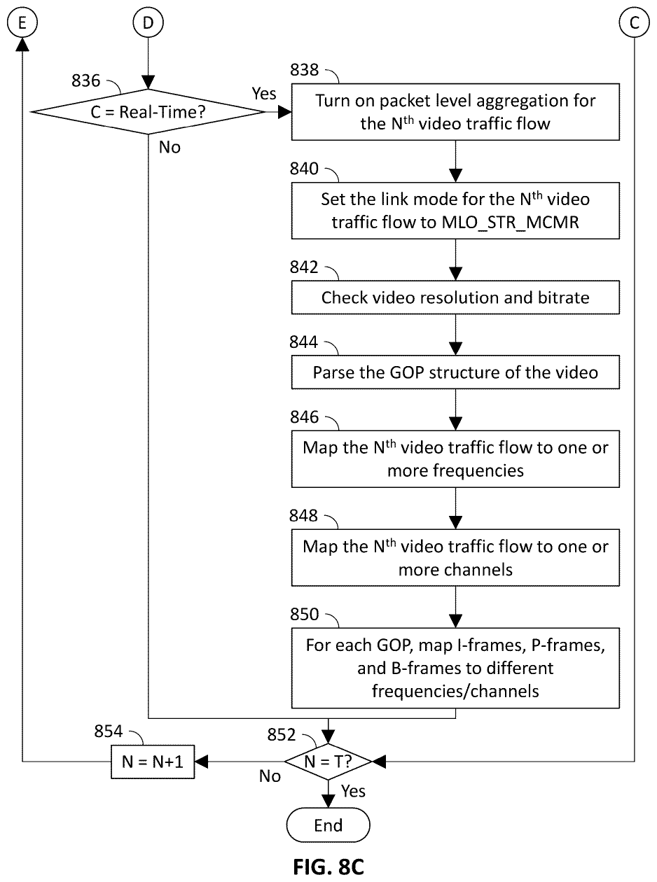

FIGS. 8A, 8B, and 8C (collectively, FIG. 8) together are a flowchart representing an illustrative process 800 for assigning a traffic flow to one or more channels based on the type of the traffic flow, in accordance with some embodiments of this disclosure. Process 800 may be implemented on control circuitry 608. In addition, one or more actions of process 800 may be incorporated into or combined with one or more actions of any other process or embodiments described herein.

At 802, control circuitry 608 initializes a counter variable N, setting its initial value to 1, and a variable T representing the number of video traffic flows at the last mile access point. The method described above in connection with FIG. 7 may be used to identify video traffic flows. At 804, control circuitry 608 initializes a variable C representing a classification of the N^{th} video flow.

At 806, control circuitry 608 determines whether the N^{th} video flow is classified as streaming video-on-demand (SVOD). If so (“Yes” at 806), then, at 810, control circuitry 608 turns on flow level aggregation for the N^{th} video traffic flow. Flow level aggregation is a mechanism used to combine multiple packets belonging to the same or related communication flows into a single aggregated frame for transmission. This process improves the efficiency of the wireless medium by reducing protocol overhead and maximizing the use of available bandwidth.

At 810, control circuitry 608 sets the link mode for the N^{th} video traffic flow to SLO. This allows the user device associated with the N^{th} video traffic flow to use only a single channel for data upload and download, as additional bandwidth is not needed for SVOD.

If the N^{th} video traffic flow is not classified as SVOD (“No” at 806), then, at 812, control circuitry 608 determines whether the N^{th} video traffic flow is classified as unreliable live video. If so (“Yes” at 812), then, at 814, control circuitry 608 turns on packet level aggregation for the N^{th} video traffic flow. Packet level aggregation is a process in which multiple packets are combined into a single larger transmission unit at the MAC layer to improve the efficiency of wireless communication. By reducing the overhead associated with transmitting each packet individually, aggregation enhances throughput and minimizes delays.

At 816, control circuitry 608 sets the link mode for the N^{th} video traffic flow to NSTR_MLO. This allows the user device associated with the N^{th} video traffic flow to use multiple channels for data upload and download in a non-simultaneous manner. For example, the user device may upload data requests on a first channel at times when video data is not being downloaded, and download video data on a second channel during times when data requests are not being uploaded.

At 818, control circuitry 608 checks the video resolution and bitrate of the N^{th} video traffic flow. At 820, control circuitry 608 maps the N^{th} video traffic flow to one or more frequencies, depending on the video resolution and bitrate. At 822, control circuitry 608 similarly maps the N^{th} video traffic flow to one or more channels. Generally, for higher bitrates and/or higher resolutions, the traffic flow is mapped to additional frequencies/channels.

If the N^{th} video traffic flow is not classified as unreliable live (“No” at 812), then, at 824, control circuitry 608 determines whether the N^{th} video traffic flow is classified as reliable live. If so (“Yes” at 824), then, at 826, control circuitry 608 turns on packet level aggregation for the N^{th} video traffic flow. At 828, control circuitry 608 sets the link mode for the N^{th} video traffic flow to MLO_MCMR. This allows the user device associated with the N^{th} video traffic flow to use multiple channels at multiple frequencies for uploading and/or streaming data. At 830, control circuitry 608 checks the video resolution and bitrate. At 832, control circuitry 608 maps the N^{th} video traffic flow to one or more frequencies based on the resolution and bitrate. At 834, control circuitry 608 maps the N^{th} video traffic flow to one or more channels.

If the N^{th} video traffic flow is not classified as reliable live (“No” at 824), then, at 836, control circuitry 608 determines whether the N^{th} video traffic flow is classified as real-time. If so (“Yes” at 836), then, at 838, control circuitry 608 turns on packet level aggregation for the N^{th} video traffic flow. At 840, control circuitry 608 sets the link mode for the N^{th} video traffic flow to MLO_STR_MCMR. This allows the user device associated with the N^{th} video traffic flow to use multiple channels at multiple frequencies simultaneously for uploading and/or downloading data. At 842, control circuitry 608 checks the video resolution and bitrate. At 844, control circuitry 608 parses the GOP structure of the video. For example, control circuitry 608 analyzes and interprets the organization of video frames within the video stream to identify I-frames and predicted frames (P-/B-frames). Control circuitry 608 may also determine the GOP size and order/distribution of different frame types within the GOP.

At 846, control circuitry 608 maps the N^{th} video traffic flow to one or more frequencies based on the resolution and/or bitrate. At 848, control circuitry 680 maps the N^{th} video traffic flow to one or more channels. At 850, control circuitry 608 maps I-frames, P-frames, and B-frames for each GOP to different frequencies/channels.

After processing the N^{th} video traffic flow in this manner, at 852, control circuitry 608 determines whether N is equal to T, meaning that all video traffic flows have been processed. If Nis not equal to T (“No” at 852), then, at 854, control circuitry 608 increments the value of N by one, and processing returns to 804. If N is equal to T (“Yes” at 852), then the process ends.

The actions and descriptions of FIG. 8 may be used in any other embodiment of this disclosure. In addition, the actions and descriptions described in relation to FIG. 8 may be done in suitable alternative orders or in parallel to further the purposes of this disclosure.

For uplink video streaming traffic, separately from application level tag that can be mapped to the MoQ object format, there may be intermittent latency-sensitive operations that occur alongside the video streaming session. One example for this is placing a micro-bet that is closely associated with received the live stream. For this intermittent, randomly recurring need, the Target Wake up functionality of 802.11be may be used to ensure that other links go into a temporary sleep till the placed micro-bet data is uploaded. More than one link may be placed into sleep mode to reduce or remove interference.

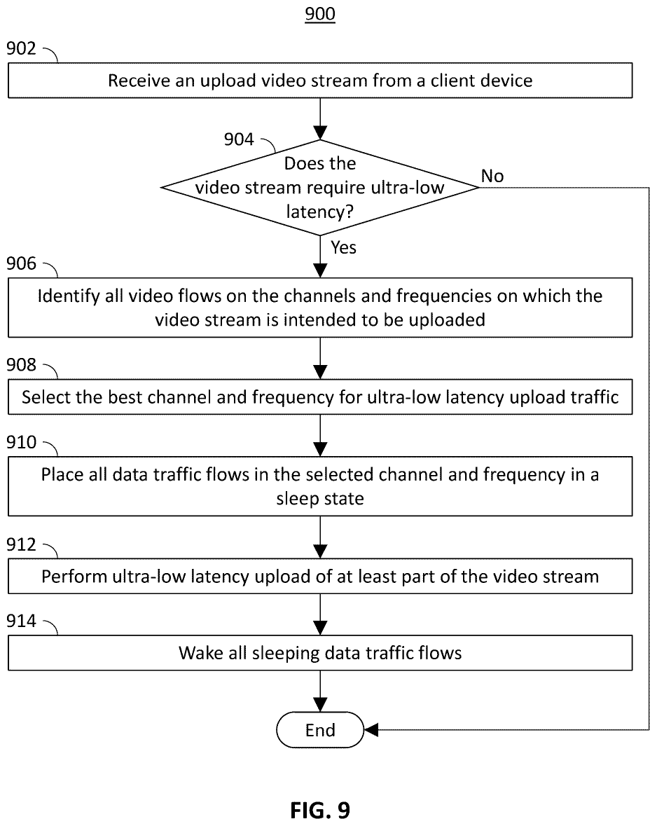

Video traffic flows may also be uploaded by client devices. FIG. 9 is a flowchart representing an illustrative process 900 for performing low-latency upload transmissions, in accordance with some embodiments of this disclosure. Process 800 may be implemented on control circuitry 608. In addition, one or more actions of process 800 may be incorporated into or combined with one or more actions of any other process or embodiments described herein.

At 902, control circuitry 608 receives an upload video stream from a client device. For example, a client device may be live streaming a sports event, a social media event, or other live video session.

At 904, control circuitry 608 determines whether the video stream requires ultra-low latency. For example, an upload video stream for a social media event may not require ultra-low latency, whereas an upload video stream of a sports event or online game may require ultra-low latency. If the upload stream does not require ultra-low latency, then the process ends.

If, however, the upload video stream does require ultra-low latency (“Yes” at 904), then, at 906, control circuitry 608 identifies all video flows on the channels and frequencies on which the video stream is intended to be uploaded. This may be accomplished using methods described above in connection with FIG. 7.

At 908, control circuitry 608 selects the best channel and frequency for ultra-low latency upload traffic. This selection may be based on channel bandwidth, signal strength, interference profiles, or any other information relating to each channel. At 910, control circuitry 608 temporarily places all data traffic flows in the selected channel and frequency into a sleep state. In some embodiments, the channel may be selected on the basis of whether other data flows on the channel can tolerate being placed into a sleep state for any period of time.

At 912, control circuitry 608 performs ultra-low latency upload of at least part of the video stream. The amount of data uploaded may be depend on the length of time other data traffic flows on the channel/frequency can tolerate being held in a sleep state. At 914, after at least part of the video stream has been uploaded, control circuitry 608 wakes all sleeping data traffic flows.

The actions and descriptions of FIG. 9 may be used in any other embodiment of this disclosure. In addition, the actions and descriptions described in relation to FIG. 9 may be done in suitable alternative orders or in parallel to further the purposes of this disclosure.

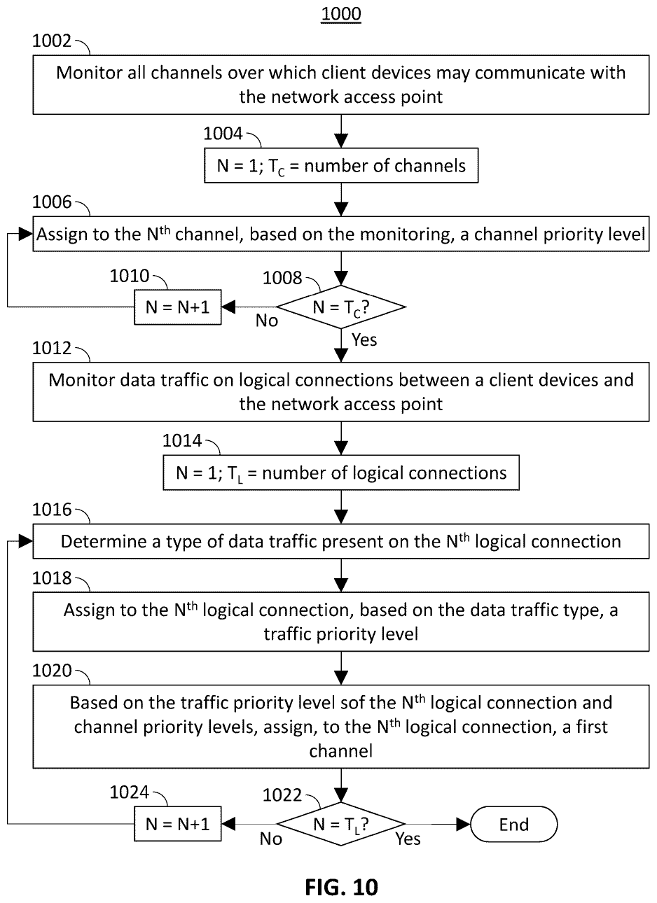

FIG. 10 is a flowchart representing an illustrative process 1000 for performing low-latency upload transmissions, in accordance with some embodiments of this disclosure. Process 800 may be implemented on control circuitry 608. In addition, one or more actions of process 800 may be incorporated into or combined with one or more actions of any other process or embodiments described herein.

At 1002, control circuitry 608 monitors all channels over which client devices may communicate with AP 600. Each channel in each frequency band used by AP 600 (e.g., 2.4 GHz, 5 GHZ, and 6 GHz) is monitored to determine whether it is in use. If a channel is in use, the monitoring may also determine the type of data traffic on that channel. The monitoring may also identify signal characteristics of each channel, including interference, signal strength, etc.

At 1004, control circuitry 608 initializes a counter variable N, setting its initial value to 1, and a variable Tc representing the number of channel monitored. At 1006, control circuitry 608 assigns to the N^{th} channel, based on the monitoring, a channel priority level. Based on the signal characteristics of a channel, a channel priority level is assigned to that channel. For example, a channel in a lower frequency band (e.g., 2.4 GHz band 200) has less bandwidth, and therefore less data throughput, than higher frequency bands. Accordingly, a 2.4 GHz channel may be assigned a low channel priority level. In another example, a channel in a high frequency band (e.g., 6 GHz band 204) has higher bandwidth/data throughput and might normally be assigned a high channel priority level. However, if the channel is experiencing interference (e.g., from an adjacent channel in 6 GHz band 204 or from an environmental source), the channel may be assigned a medium or even low channel priority level.

At 1008, control circuitry 608 determine whether N is equal to Tc, meaning that a channel priority level has been assigned to every channel. If N is not equal to Tc (“No” at 1008), then, at 1010, control circuitry 608 increments the value of N by one, and processing returns to 1006.

If N is equal to Tc, (“Yes” at 1008), then, at 1012, control circuitry monitors data traffic on logical connections between client devices and AP 600. At 1014, control circuitry 608 resets the value of N to 1 and initialized a variable TL representing a number of logical connections that are active at AP 600.

At 1016, control circuitry 608 determines a type of data traffic present on the N^{th} logical connection. This may be accomplished using methods described above in connection with FIG. 7. At 1018, control circuitry 608 assigns a traffic priority level to the N^{th} logical connection based on the data traffic type. For example, a channel that is currently being used for simple and/or periodic data transfer, such as by an IoT device, may be assigned a low data traffic priority level. A channel that is being used for streaming video on-demand may also be assigned a low priority. This is because, for video-on-demand, content can be downloaded a buffered ahead of a current playback position within the content, making the streaming sessions more tolerant of interruption than other types of streaming sessions. A channel that is being used for “unreliable live” content, meaning content that is live but does not require low latency, may be assigned a medium data traffic priority level because an unreliable live session can tolerate some minor interruptions. A channel that is being used for “reliable live” and “real-time” content, which require low latency and high bandwidth, may be assigned a high data traffic priority level.

At 1020, control circuitry 608 assigns a first channel to the N^{th} logical connection based on the traffic priority level of the N^{th} logical connection and the channel priority levels. For example, is the type of data traffic present on the N^{th} logical connection is a real-time video stream that requires low or ultra-low latency, control circuitry 608 may assign to the N^{th} logical connection a channel in the highest available frequency band (e.g., 6 GHZ) that has the highest signal strength, lest interference, and is not currently in use by another logical connection. If the type of data traffic present on the N^{th} logical connection is an SVOD session, control circuitry 608 may assign to the N^{th} logical connection a channel in a lower frequency band (e.g., 5 GHz or 2.4 GHz) that may experience some interference of reduction of signal strength, as an SVOD session may be more tolerant of dropped frames/packets.

At 1022, control circuitry 608 determines whether N is equal to TL, meaning that a channel has been assigned to every logical connection. If N is not equal to TL (“No” at 1022), then, at 1024, control circuitry 608 increments the value of N by one, and processing returns to 1016. If N is equal to TL (“Yes” at 1022), then the process ends.

The actions and descriptions of FIG. 10 may be used in any other embodiment of this disclosure. In addition, the actions and descriptions described in relation to FIG. 10 may be done in suitable alternative orders or in parallel to further the purposes of this disclosure.

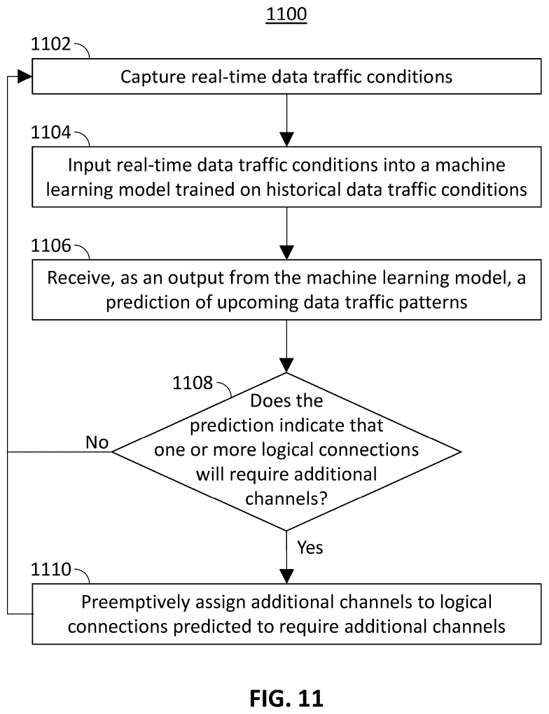

FIG. 11 is a flowchart representing an illustrative process 1100 for preemptively assigning additional channels to logical connections based on predicted data traffic conditions, in accordance with some embodiments of this disclosure. Process 1100 may be implemented on control circuitry 608. In addition, one or more actions of process 1000 may be incorporated into or combined with one or more actions of any other process or embodiments described herein.

At 1102, control circuitry 608 captures real-time data traffic conditions. For example, control circuitry 608 may, in monitoring the channels and logical connections, assemble a list, table, or data structure representing the current data traffic on each channel and on each logical connection.

At 1104, control circuitry 608 inputs the real-time data traffic conditions into a machine learning model that has been trained on historical data traffic conditions. The machine learning model may take the real-time data traffic conditions and output a prediction of upcoming data traffic patterns. At 1106, control circuitry 608 receives this output from the machine learning model.

At 1108, control circuitry 608 determines whether the prediction indicates that one or more logical connections will require additional channels. For example, the prediction may indicate that a logical connection will soon be uploading a live video stream that requires ultra-low latency. If control circuitry 608 determines that the prediction does indicate that a logical connection will require additional channels (“Yes” at 1108), then, at 1110, control circuitry 608 preemptively assigned additional channels to logical connections predicted to require them. After preemptively assigning the additional channels, or if the prediction does not indicate that any logical connections will require additional channels (“No” at 1108), processing returns to 1102. In some embodiments, there is a delay before returning to 1102 to allow time for current data traffic conditions to appreciably change before obtaining another prediction.

The actions and descriptions of FIG. 11 may be used in any other embodiment of this disclosure. In addition, the actions and descriptions described in relation to FIG. 11 may be done in suitable alternative orders or in parallel to further the purposes of this disclosure.

In some embodiments, the transmission of streaming video from an external network to the last-mile access point may rely on traditional streaming technologies such as MPEG-DASH, HTTP adaptive bitrate (ABR), or Low-Latency HLS (LL HLS) streaming. These technologies are widely used for delivering content over the Internet, utilizing HTTP protocols to adapt the quality of the stream to the network conditions and ensuring consistent playback for the end user. The access point acts as a bridge between these established streaming formats and newer, more flexible delivery mechanisms, enabling seamless integration with modern media delivery systems.

Upon receiving the stream in one of these traditional formals, the access point utilize an ABR-to-MoQ protocol to transcode the incoming stream into MoQ format. Once the stream is converted to MoQ format, the access point can employ intelligent methods to assign different traffic flows to appropriate wireless channels. For example, it may map essential components of the stream, such as base layers or critical metadata, to channels with higher reliability and lower congestion (e.g., the 6 GHz band). Meanwhile, enhancement layers or less critical components of the stream can be assigned to other channels, such as the 5 GHz band, to optimize the use of available spectrum. This channel allocation strategy ensures efficient utilization of network resources while maintaining high-quality delivery of media content to end devices.

This approach provides significant benefits. By combining the widespread compatibility and deployment of traditional streaming technologies with the flexibility and efficiency of MoQ, the system can deliver a seamless viewing experience even in challenging network conditions. The access point's ability to dynamically transcode and intelligently route traffic also enhances network resilience, ensuring that critical content is prioritized and delivered without interruptions. Furthermore, this integration supports advanced features like adaptive streaming and load balancing, making it ideal for high-demand applications such as video conferencing, live events, and large-scale media streaming platforms.

In some embodiments, the MoQTransport/Transfork object codec format is Scalable Video Coding (SVC), the video stream is divided into multiple layers based on the codec's scalability features. The base layer of the video stream and the enhancement layer of the video stream may be mapped to different channels to optimize performance. For example, the base layer, which contains essential information for basic playback (such as low resolution or low frame rate video) may be transmitted over a 6 GHz channel. The 6 GHz band offers higher bandwidth and reduced congestion due to limited legacy device usage. In contrast, the enhancement layers, which add details like higher resolution or higher frame rate, may be transmitted over a 5 GHz channel which, while more crowded that the 6 GHz band, is still well-suited for delivering streaming video data.

This approach offers several benefits. By distributing the layers across different frequency bands, network congestion is reduced, ensuring smoother video delivery. The base layer, prioritized for uninterrupted playback, benefits from the reliable and less congested 6 GHz spectrum, while the enhancement layers can leverage the 5 GHz band for additional data without impacting essential functionality. If the enhancement layer's channel experiences interference or reduced capacity, the system can still provide a functional video stream by relying solely on the base layer, ensuring continuity even in suboptimal conditions. Additionally, the 6 GHz band's wider channels and higher capacity ensure minimal packet loss and jitter for the base layer, while the 5 GHz band flexibly accommodates enhancement data based on available bandwidth.

This layered approach is particularly useful in applications like video conferencing, where the base layer ensures seamless communication and synchronization, and the enhancement layers provide optional higher-quality visuals. Mapping decisions may be influenced by real-time channel conditions, network policies, and device capabilities, with modern Wi-Fi 7 and beyond enabling devices to operate simultaneously on both bands. By intelligently leveraging SVC and mapping its layers to different channels, systems can maintain a robust user experience while optimizing network resources.

In some embodiments, while applying a channel priority level to a channel based on its radio characteristics, the access point may selectively reduce the modulation coding scheme (MCS) for a channel that is mapped to a high priority data traffic flow. The MCS refers to the combination of modulation techniques and error-correcting code rates used to transmit data over wireless networks. Reducing the MCS results in a channel with greater reliability and lower latency. For example, the modulation may be changed from 64-QAM, which requires 6 to 8 bits per symbol to transmit, to QPSK, while requires only 2 bits per symbol. Lower modulation schemes like QPSK are less susceptible to errors caused by noise, interference, and weak signals. This means the data can be received and decoded correctly even under challenging conditions, such as at greater distances or in crowded RF environments. The coding rate may also be adjusted to change the amount of redundant bits included in the transmission for error correction purposes. This may be used in delivering, for example, a “reliable live” MoQ stream.

The processes described above are intended to be illustrative and not limiting. One skilled in the art would appreciate that the steps of the processes described herein may be omitted, modified, combined, and/or rearranged, and any additional steps may be performed without departing from the scope of this disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should be noted that the systems and/or methods described above may be applied to, or used in accordance with, other systems and/or methods.

1. A method for intelligent spectrum aware data traffic routing, the method comprising:
monitoring a plurality of channels over which devices may communicate with a network access point to communicate with one or more network nodes communicatively coupled to the network access point;
assigning to each channel of the plurality of channels, based on the monitoring, a channel priority level;
monitoring data traffic present on logical connections over the plurality of channels between a plurality of devices and the network access point, wherein each logical connection allows communication between a respective device of the plurality of devices and the network access point over at least one channel of the plurality of channels;
determining, for each respective logical connection, a type of data traffic present on the respective logical connection;
based on the type of data traffic present on the respective logical connection, assigning, to the respective logical connection, a traffic priority level; and
based at least in part on the traffic priority level assigned to the respective logical connection and the channel priority level assigned to each channel of the plurality of channels, assigning, to the respective logical connection, one or more channels of the plurality of channels over which the respective device associated with the respective logical connection is to communicate with the network access point.

2. The method of claim 1, wherein each respective logical connection facilitates communication between a respective device and the one or more nodes communicatively coupled to the network access point.

3. The method of claim 1, wherein at least one of the one or more nodes communicatively coupled to the network access point is upstream from the network access point.

4. The method of claim 1, wherein at least one of the one or more nodes communicatively coupled to the network access point is downstream from the network access point.

5. The method of claim 1, wherein assigning, to the respective logical connection, one or more channels of the plurality of channels comprises:
assigning both a first channel and a second channel of the plurality of channels to the respective logical connection, based on a respective channel priorities of the first and second channels and the traffic priority level assigned to the respective logical connection, over which the respective device associated with the respective logical connection is to communicate with the network access point such that the respective device will communicate with the network access point using both the first and second channels.

6. The method of claim 5, wherein the second channel exists on a different frequency band than the first channel.

7. The method of claim 5, further comprising utilizing the first channel exclusively for transmitting data and, simultaneously, utilizing the second channel exclusively for receiving data.

8. The method of claim 5, further comprising utilizing each of the first and second channels for both transmitting data to and receiving data from the respective device.

9. The method of claim 1, wherein determining, for each respective logical connection, a type of data traffic present on the respective logical connection further comprises determining a latency requirement associated with the data traffic.

10. The method of claim 9, wherein assigning, to the respective logical connection, a traffic priority level is based at least in part on a latency tolerance of the data traffic, and wherein assigning, to the respective logical connection, the one or more channels of the plurality of channels over which the respective device associated with the respective logical connection is to communicate with the network access point further comprises assigning, to the respective logical connection, a channel in a highest available frequency band.

11. The method of claim 1, wherein determining, for each respective logical connection, a type of data traffic present on the respective logical connection further comprises determining whether the data traffic is upload traffic or download traffic.

12. The method of claim 1, wherein determining, for each respective logical connection, a type of data traffic present on the respective logical connection comprises receiving, from the respective device associated with the respective logical connection, a data traffic type tag.

13. The method of claim 1, wherein determining, for each logical connection, a type of data traffic present on the respective logical connection comprises:
inspecting one or more data packets being transmitted through the logical connection; and
determining, based on the inspecting, a type of data traffic.

14. The method of claim 1, further comprising:
predicting data traffic patterns, based on real-time data traffic conditions, using a machine learning model trained on historical data traffic conditions; and
preemptively assigning additional channels to respective logical connections based on the predicted data traffic patterns.

15. The method of claim 1, further comprising:
determining a latency tolerance of the data traffic being transmitted over a first logical connection; and
in response to determining that the data traffic being transmitted over the first logical connection has a low latency tolerance:
identifying one or more logical connections having data traffic that has a higher latency tolerance; and
modifying data traffic use of at least one identified logical connection.

16. The method of claim 15, wherein modifying data traffic use of at least one identified logical connection comprises:
periodically suspending data traffic on at least one identified logical connection to increase available bandwidth for the data traffic being transmitted over the first logical connection.

17. The method of claim 15, wherein modifying data traffic use of at least one identified logical connection comprises:
reassigning a channel assigned to the at least one identified logical connection to the first logical connection; and
assigning a third channel to the at least one identified logical connection.

18. The method of claim 1, wherein monitoring a plurality of channels over which devices may communicate with a network access point comprises monitoring at least one of an amount of data traffic or a type of data traffic present on each channel of the plurality of channels.

19. The method of claim 1, wherein monitoring a plurality of channels over which devices may communicate with a network access point comprises determining, for each respective channel of the plurality of channels, whether the respective channel is assigned to a logical connection.

20. The method of claim 1, wherein monitoring a plurality of channels over which devices may communicate with a network access point comprises determining radio characteristics of each channel, the radio characteristics including one or more of signal interference, signal strength, or available bandwidth.

21. A system for intelligent spectrum aware data traffic routing through a network access point, the system comprising:
a transceiver configured to transmit and receive data over a plurality of channels in a plurality of frequency bands; and
control circuitry configured to:
monitor a plurality of channels over which devices may communicate with the network access point to communicate with one or more network nodes communicatively coupled to the network access point;
assign to each channel of the plurality of channels, based on the monitoring, a channel priority level;
monitor data traffic present on logical connections over the plurality of channels between a plurality of devices and the network access point, wherein each logical connection allows communication between a respective device of the plurality of devices and the network access point over at least one channel of the plurality of channels;
determine, for each respective logical connection, a type of data traffic present on the respective logical connection;
based on the type of data traffic present on the respective logical connection, assign, to the respective logical connection, a traffic priority level; and
based at least in part on the traffic priority level assigned to the respective logical connection and the channel priority level assigned to each channel of the plurality of channels, assign, to the respective logical connection, one or more channels of the plurality of channels over which the respective device associated with the respective logical connection is to communicate with the network access point.

22. The system of claim 21, wherein each respective logical connection facilitates communication between a respective device and the one or more nodes communicatively coupled to the network access point.

23. The system of claim 21, wherein at least one of the one or more nodes communicatively coupled to the network access point is upstream from the network access point.

24. The system of claim 21, wherein at least one of the one or more nodes communicatively coupled to the network access point is downstream from the network access point.

25. The system of claim 21, wherein the control circuitry configured to assign, to the respective logical connection, one or more channels of the plurality of channels further comprises:
assign both a first channel and a second channel of the plurality of channels to the respective logical connection, based on a respective channel priorities of the first and second channels and the traffic priority level assigned to the respective logical connection, over which the respective device associated with the respective logical connection is to communicate with the network access point such that the respective device will communicate with the network access point using both the first and second channels.

26. The system of claim 25, wherein the second channel exists on a different frequency band than the first channel.

27. The system of claim 25, wherein the control circuitry is further configured to, using the transceiver, utilize the first channel exclusively for transmitting data and, simultaneously, utilize the second channel exclusively for receiving data.

28. The system of claim 25, wherein the control circuitry is further configured to, using the transceiver, utilize each of the first and second channels for both transmitting data to and receiving data from the respective device.

29. The system of claim 21, wherein the control circuitry configured to determine, for each respective logical connection, a type of data traffic present on the respective logical connection is further configured to determine a latency requirement associated with the data traffic.

30. The system of claim 29, wherein the control circuitry configured to assign, to the respective logical connection, a traffic priority level is configured to do so based at least in part on a latency tolerance of the data traffic, and wherein the control circuitry configured to assign, to the respective logical connection, the one or more channels of the plurality of channels over which the respective device associated with the respective logical connection is to communicate with the network access point is further configured to assign, to the respective logical connection, a channel in a highest available frequency band.

31. The system of claim 21, wherein the control circuitry configured to determine, for each respective logical connection, a type of data traffic present on the respective logical connection is further configured to determine whether the data traffic is upload traffic or download traffic.

32. The system of claim 21, wherein the control circuitry configured to determine, for each respective logical connection, a type of data traffic present on the respective logical connection is further configured to receive, from the respective device associated with the respective logical connection, a data traffic type tag.

33. The system of claim 21, wherein the control circuitry configured to determine, for each logical connection, a type of data traffic present on the respective logical connection is further configured to:
inspect one or more data packets being transmitted through the logical connection; and determine, based on the inspecting, a type of data traffic.

34. The system of claim 21, wherein the control circuitry is further configured to:
predict data traffic patterns, based on real-time data traffic conditions, using a machine learning model trained on historical data traffic conditions; and
preemptively assign additional channels to respective logical connections based on the predicted data traffic patterns.

35. The system of claim 21, wherein the control circuitry is further configured to:
determine a latency tolerance of the data traffic being transmitted over a first logical connection; and
in response to determining that the data traffic being transmitted over the first logical connection has a low latency tolerance:
identify one or more logical connections having data traffic that does has a higher latency tolerance; and
modify data traffic use of at least one identified logical connection.

36. The system of claim 35, wherein the control circuitry configured to modify data traffic use of at least one identified logical connection is further configured to:
periodically suspend data traffic on at least one identified logical connection to increase available bandwidth for the data traffic being transmitted over the first logical connection.

37. The system of claim 35, wherein the control circuitry configured to modify data traffic use of at least one identified logical connection is further configured to:
reassign a channel assigned to the at least on identified logical connection to the first logical connection; and
assign a third channel to the at least one identified logical connection.

38. The system of claim 21, wherein the control circuitry configured to monitor a plurality of channels over which devices may communicate with a network access point is further configured to monitor at least one of an amount of data traffic or a type of data traffic present on each channel of the plurality of channels.

39. The system of claim 21, wherein the control circuitry configured to monitor a plurality of channels over which devices may communicate with a network access point is further configured to determine, for each respective channel of the plurality of channels, whether the respective channel is assigned to a logical connection.

40. The system of claim 21, wherein the control circuitry configured to monitor a plurality of channels over which devices may communicate with a network access point is further configured to determine radio characteristics of each channel, the radio characteristics including one or more of signal interference, signal strength, or available bandwidth.

41-100. (canceled)
